(19) United States
(12) Patent Application Publication
(10) Pub. No.: US 2026/0138912 A1
(43) Pub. Date: May 21, 2026

(54) SEALING OF A CANE ASSEMBLY USING A RAPID, HEAT CURING SEALING MATERIAL FOR HOLLOW CORE FIBER MANUFACTURING

(71) Applicant: Microsoft Technology Licensing, LLC, Redmond, WA (US)

(72) Inventor: Mariana Fatobene ANDO, Romsey (GB)

(73) Assignee: Microsoft Technology Licensing, LLC, Redmond, WA (US)

(21) Appl. No.: 18/950,398

(22) Filed: Nov. 18, 2024

(51) Int. Cl. C03B 37/012; C03B 37/025

(52) U.S. Cl. CPC C03B 37/01208; C03B 37/0256

(57) ABSTRACT

Systems and methods are provided for implementing sealing of a cane assembly using a rapid, heat curing sealing material for hollow-core fiber (“HCF”) manufacturing. In examples, an addition-curing silicone elastomer-based sealing material is first prepared by causing a rolling machine to roll a container containing a silicone polymer at a first rotation speed for a first duration to homogenize the silicone polymer. A planetary mixer mixes the homogenized silicone polymer with a catalyst at a weight ratio of 9:1, for a second rotation speed for a second duration, and de-aerates the mixture. The sealing material is applied at an end of an HCF cane and cured at between 70 and 200° C. for less than two hours. An inert gas is pumped in at the end of the HCF cane while an opposite end of the cane is drawn through a heated chamber to form the HCF.

### BACKGROUND

Hollow core fibers (“HCFs”) are manufactured from drawing HCF canes across a distance as the HCF canes are heated, thereby resulting in the eventual outer diameter and length characteristics of optical fibers. Because HCFs (such as nested anti-resonant nodeless fiber (“NANF”) or double-nested anti-resonant nodeless fiber (“D-NANF”), etc.) have tubular and/or other structures formed on an inner surface of corresponding HCF canes, drawing such canes across a distance to form the corresponding HCFs may damage the tubular structures. Accordingly, pressurization of an internal space within the canes is used to protect the tubular structures during the drawing process. It is with respect to this general technical environment to which aspects of the present disclosure are directed. In addition, although relatively specific problems have been discussed, it should be understood that the examples should not be limited to solving the specific problems identified in the background.

### SUMMARY

This summary is provided to introduce a selection of concepts in a simplified form that are further described below in the detailed description section. This summary is not intended to identify key features or essential features of the claimed subject matter, nor is it intended as an aid in determining the scope of the claimed subject matter.

The currently disclosed technology, among other things, provides for sealing of a cane assembly using a rapid, heat curing sealing material for HCF manufacturing. In examples, an addition-curing silicone elastomer-based sealing material is first prepared by causing a rolling machine to roll a container containing a silicone polymer at a first rotation speed for a first duration to homogenize the silicone polymer by maintaining a Froude number between 0.070 and 0.080 during rolling. In examples, a planetary mixer mixes the homogenized silicone polymer with a catalyst at a weight ratio of about 9:1, for a duration of less than 10 minutes at a rotation speed of between 1800 and 2200 revolutions per second, and de-aerates the mixture. The sealing material is applied at an end of a hollow-core fiber (“HCF”) cane and may be cured at a temperature between 70 and 200 degrees Celsius (° C.) for less than two hours. An inert gas is pumped in at the end of the HCF cane while an opposite end of the cane is drawn through a heated chamber to form the HCF.

The details of one or more aspects are set forth in the accompanying drawings and description below. Other features and advantages will be apparent from a reading of the following detailed description and a review of the associated drawings. It is to be understood that the following detailed description is explanatory only and is not restrictive of the invention as claimed.

### BRIEF DESCRIPTION OF THE DRAWINGS

A further understanding of the nature and advantages of particular embodiments may be realized by reference to the remaining portions of the specification and the drawings, which are incorporated in and constitute a part of this disclosure.

FIG. 1 depicts an example diagrammatic partial process flow for implementing sealing of a cane assembly using a rapid, heat curing sealing material for hollow core fiber manufacturing.

FIGS. 2A and 2B depict example fluid motions that are caused to homogenize Component A of the rapid, heat curing sealing material of FIG. 1, when using a rolling machine.

FIG. 3 depicts example motions that are caused when mixing Components A and B of the rapid, heat curing sealing material of FIG. 1, when using a planetary mixer.

FIGS. 4 and 4A-4E depict an example method for implementing sealing of a cane assembly using a rapid, heat curing sealing material for hollow core fiber manufacturing.

FIG. 5 depicts another example method for implementing sealing of a cane assembly using a rapid, heat curing sealing material for hollow core fiber manufacturing.

### DETAILED DESCRIPTION OF CERTAIN EMBODIMENTS

As briefly discussed above, during manufacturing of the HCFs, pressurization of an internal space within the canes is used to protect the tubular structures during the drawing process. To enable pressurization of an internal space within the HCF cane, a sealing material is applied at one end of an HCF cane. An inert gas is then pumped through pressurization tubes extending through the sealing material. The pressurization of the internal space within the HCF cane protects tubular or other structures formed on an interior surface of the HCF cane (such as canes for NANF, D-NANF, or other HCF structures) during the drawing process.

Existing sealing materials, however, require an extended amount of time to cure (e.g., about 24 hours or longer) and, in some cases, may outgas gases (e.g., carbon dioxide) that can contaminate interior spaces or surfaces of HCFs during the drawing process. In some instances, the contaminant gases can affect subsequent transmission of optical data signals due to signal absorption by the contaminant gases, resulting in transmission losses, in some cases, greater than 0.5 decibels per kilometer (dB/km). In examples, gas line absorption (“GLA”) from optically active gas molecules is recognized as one of the most important causes of transmission impairment over long distances in HCFs. Carbon dioxide (CO₂) is the most prevalent of gas absorbing species in HCFs, and originates from several material, process, and environmental factors. Prior evidence has shown that outgassing from silicone materials used for sealing the canes and/or preforms is a major (though not the only) contributor to CO₂.

The present technology provides for sealing of a cane assembly using a rapid, heat curing sealing material for HCF manufacturing. The rapid, heat curing sealing material may be an addition-curing silicone elastomer-based material that is non-toxic, that can be cured in a fraction of the time that conventional sealing materials require to cure (e.g., 5-10 mins or up to two hours). The material may also be cured at moderate temperatures during that curing time (e.g., between 70 and 200° C., and the material may be stable over varying humidity conditions.

The material also has low outgassing properties that lower emission of organic gases (e.g., CO₂), thus mitigating risk of contaminating interior spaces or surfaces of HCFs that could subsequently impact transmission loss due to absorption by the organic gases. For the low outgassing characteristic, the process steps (e.g., de-aerating step as described in detail below with respect to the figures) together with the composition of the addition-curing silicone elastomer-based material (as also described in detail below with respect to the figures) result in production of HCFs that exhibit CO₂ outgassing levels having average transmission losses less than 0.05 dB/km, in some cases, less than 0.03 dB/km, and in still other cases, less than 0.15 dB/km, as compared with the greater than 0.5 dB/km transmission losses due to CO₂ or other contaminant gases that are at least in part contributed by conventional sealing materials used to form HCFs. Furthermore, the addition-curing silicone elastomer-based material enables easier batching and preparation, which increases suitability for automated preparation.

Various modifications and additions can be made to the embodiments discussed herein without departing from the scope of the disclosed techniques. For example, while the embodiments described above refer to particular features, the scope of the disclosed techniques also includes embodiments having different combinations of features and embodiments that do not include all of the above-described features.

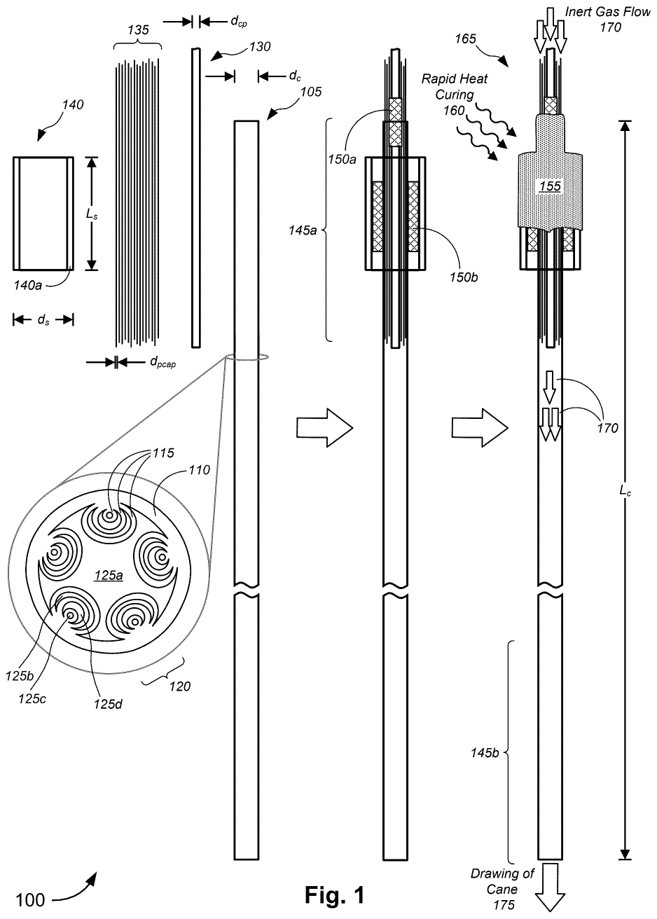

Turning to the embodiments as illustrated by the drawings, FIGS. 1-5 illustrate some of the features of methods, systems, and apparatuses for implementing hollow core fiber manufacturing or, more particularly, for implementing sealing of a cane assembly using a rapid, heat curing sealing material for hollow core fiber manufacturing, as referred to above. The methods, systems, and apparatuses illustrated by FIGS. 1-5 refer to examples of different embodiments that include various components and steps, which can be considered alternatives or which can be used in conjunction with one another in the various embodiments. The description of the illustrated methods, systems, and apparatuses shown in FIGS. 1-5 is provided for purposes of illustration and should not be considered to limit the scope of the different embodiments.

FIG. 1 depicts an example diagrammatic partial process flow 100 for implementing sealing of a cane assembly 165 using a rapid, heat curing sealing material 155 for hollow core fiber manufacturing. Two lateral block arrows pointing from left to right in FIG. 1 indicate a transition from individual components of the cane assembly (e.g., leftmost set of components, to the left of both arrows in FIG. 1) to an intermediate cane assembly (e.g., middle structure, between the two arrows in FIG. 1) to a pressure-sealed cane assembly 165 (e.g., rightmost structure, to the right of both arrows in FIG. 1).

With reference to FIG. 1, a cane assembly 165 is formed from components including a cane 105, which includes an outer glass tube 110 and a plurality of tubes 115, groups of tubes among which are nested and fused to form a plurality of nested tubes 120. The plurality of nested tubes 120 are spaced apart along an inner circumference of the outer glass tube 110 and are fused to an inner surface of the outer glass tube 110, such as shown in the cross-sectional cut-out view of cane 105 in FIG. 1 (in this case, a cross-section corresponding to a D-NANF HCF). The configuration (or arrangement) of nested tubes 120 results in a central opening 125a that corresponds to a first space that is defined by the inner circumference of the outer glass tube 110 and an outer circumference of each of the plurality of nested tubes 120. Each of the plurality of tubes that forms a nested tube has its own opening (one of openings 125b, 125c, or 125d). The specific configuration of tubes 115 or nested tubes 120 as shown in FIG. 1 is intended to be illustrative and not limiting for the canes 105 that may be used for forming HCFs, whose nested tube configurations would mirror or match the configuration of the tubes 115 or nested tubes 120 of the cane 105. That is, in addition to the D-NANF HCF shown in the example of FIG. 1, other HCFs (e.g., NANF HCFs, multi-nested anti-resonant nodeless fiber (“M-NANF”) HCFs, or other types of HCFs) may benefit from the use of the sealing material 155 and process as described herein for preparing, applying, and curing the sealing material 155 for producing HCFs.

As shown in FIG. 1, the components of the cane assembly 165 further include a core pressurization tube 130 that is inserted and affixed within the central opening 125a of the cane 105, in some cases, with the use of a removable seal tape 150a. The components of the cane assembly 165 further include a plurality of pressurization capillary tubes 135 each of which is inserted, at a first end 145a of the cane 105, in one of the plurality of tubes 115 (e.g., in one of openings 125b, 125c, or 125d). Groups of the plurality of tubes 115 are arranged to form the plurality of nested tubes 120 of the cane 105. In an example, the components of the cane assembly 165 further include a sleeve tube 140 through which the first end 145a of the cane 105 has been inserted, the sleeve tube being affixed to a portion of an outer surface of the first end of the cane, in some cases, with the use of a removable seal tape 150b. In other examples, the sleeve tube 140 is not included as part of the cane assembly 165.

As used herein, the sleeve tube 140 (also referred to as a “sleeve capillary”) refers to a glass tube that is used to support the cane 105, and, in some cases, to mitigate or minimize formation of cracks in the cane 105 due to expansion of the sealing material 155. Herein, “capillary” refers to a micrometer diameter silica tube. To distinguish between HCF components from other components (such as pressurization tubes) that may use capillary tubes, capillary tubes that are used for particular purposes follow a naming convention herein that expressly refers to that particular purpose (e.g., “pressurization capillary tubes” or “sleeve capillary,” and so on).

As shown in FIG. 1, the cane 105 has an outer diameter d_{c} that has been drawn from a preform to a first diameter that is less than 10 millimeters (mm) (in some cases, less than about 6 mm; in still other cases, about 5.5 mm). As used herein, a preform refers to an initial glass tube from which the cane (and eventually the HCF) is formed using the drawing process. The drawing process, as used herein, refers to a fabrication process by which a preform is drawn into a fiber using a combination of gravity (e.g., with the use of a fiber drawing tower) and heat (with the use of heated chambers), with the drawn fiber having a much smaller diameter (as well as fiber features) compared with the that of the preform. In an example, the core pressurization tube 130 has an inner diameter of about 1.0 mm and an outer diameter d_{cp} of about 1.5 mm, while each pressurization capillary tube 135 has an outer diameter d_{pcap} of about 120 mm. In examples, the sleeve tube 140 (if present) has an inner diameter of about 7.3 mm and an outer diameter dₛ of about 8.3 mm.

In some examples, the first and second removable seal tapes are made from polytetrafluoroethylene (“PTFE”) film. Also known as plumber's tape or Teflon^{TM} tape, PTFE film of the removable seal tapes 150a and 150b, in some cases, are materials in tape form that act as one or more of a deformable filler, a lubricating surface, and/or a non-reactive surface. In this manner, the removable seal tape 150b, when wrapped around the portion of the outer surface of the first end of the cane with a number of overlapping turns (or revolutions), forms a relatively thick interface that when squeezed (in some cases, while rotating the cane 105 as it is inserted in the sleeve tube 140) produces a deformably tight (or close-fitting) fit within the sleeve tube 140. For example, for a 5.5 mm cane 105 and a 7.3 mm inner diameter sleeve tube 140, the thickness of the interface formed by wrapping the removable seal tape 150b around the portion of the cane 105 would be about 1.5 to about 1.8 mm. Similarly, the removable seal tape 150 a, when wrapped around a portion of an outer surface of the core pressurization tube 130 with another number of overlapping turns (or revolutions), forms a relatively thick interface that when squeezed (in some cases, while rotating the core pressurization tube 130 as it is inserted into the central opening 125a) produces a deformably tight fit within the central opening 125a of the cane 105. Due to the deformable, lubricating, and/or non-reactive properties of the seal tape, chances of damaging the surfaces contacted by the seal tape due to insertion (and subsequent extraction, such as after formation of the HCF) within the sleeve tube or within the central opening of the cane are minimized. In some cases, the surfaces contacted by the seal tape 150a or 150b include an inner surface of the sleeve tube 140 (if used), the outer surface of the cane 105 (if sleeve tube 140 is used), a portion of an outer circumference of each set of nested tubes 120 of the cane 105, and/or an outer surface of the core pressurization tube 130.

The sealing material 155 is applied to the first end 145a of the cane 105, resulting in a liquid seal, at the first end 145a of the cane 105, through which the inserted pressurization tubes (including the core pressurization tube 130 and the plurality of pressurization capillary tubes 135) extend. The sealing material 155, as used herein, is an addition-curing silicone elastomer-based material that has two components: (A) Component A, which includes a silicone polymer; and (B) Component B, which includes a catalyst. In examples, the silicone polymer has a composition including polydimethylsiloxane (“PDMS”) and a quartz-based filler. In some cases, the silicone polymer also includes auxiliary components for cross-linking as well as functional groups. In some instances, alternative to a quartz-based filler, other fillers that can be used in the silicone polymer include calcium carbonate (CaCO₃), titanium dioxide (TiO₂), glass, carbon black, and/or similar materials. In some examples, the auxiliary components include peroxides, silanes, and/or silane-containing polysiloxanes. In some cases, the functional groups include catalysts, heat stabilizers, adhesion promoters, rheology modifiers, and/or colorants.

The sealing material 155 is non-toxic, and can be cured in a fraction of the time that conventional sealing materials require to cure, as shown in the following examples. The sealing material 155 is cured, by applying heat (e.g., in a rapid heat curing phase), at a curing temperature between 70 and 200° C. (in some cases, at a temperature range between 130 and 170° C. or between 140 and 160° C.) for a curing duration that is less than two hours, resulting in a pressure seal, at the first end 145a of the cane 105, through which the inserted pressurization tubes extend (at operation 442). In some cases, the curing temperature and the curing duration that are used when curing the sealing material 155 are between 80 and 150° C. and less than 20 minutes, respectively. In some instances, the curing temperature and the curing duration that are used when curing the sealing material 155 are between 100 and 130° C. and less than 10 minutes, respectively. In other cases, the curing temperature and the curing duration that are used when curing the sealing material 155 are about 150° C. and about 5 minutes, respectively. By comparison, conventional sealing materials are curable at about room temperature (e.g., about 23° C.), and require 24 hours or longer to cure, thus the processing time for producing an HCF is reduced by at least 80 % (for the two hour cure time), in some cases by at least 99 % (for the 5-10 minute cure time).

Aside from rapid curing at moderate temperatures (e.g., between 70 and 200° C., between 130 and 170° C., or between 140 and 160° C.), the sealing material 155 is also distinguished from conventional sealing materials by its low outgassing properties as well as stability under varying humidity conditions. The low outgassing properties decrease emission of organic gases, thus mitigating the risk of contaminating interior spaces or surfaces of HCFs. One example of an addition-curing silicone elastomer-based material is Elastosil® RT 607 A/B room temperature curing silicone rubber that is available from Wacker Chemical Corporation that is based in Ann Arbor, Michigan, U.S.A.

After rapid heat curing (as denoted in FIG. 1 by curvy arrows 160), the cane assembly 165 is pressurized, by pumping an inert gas into the first end 145a of the cane 105 through the pressurization tubes 130 and 135 (as denoted in FIG. 1 by arrows 170 above and within cane 105). In some examples, the inert gas includes one or more of argon, nitrogen, helium, or other inert gas.

In examples, an HCF is formed or manufactured by vertically drawing the cane 105 (as denoted in FIG. 1 by arrow 175), by a second end 145b of the cane 105, through a heated chamber, while the cane assembly 165 is under pressure from the inert gas being pumped into the first end 145 of the cane. In this manner, the delicate structures of the nested tubes are maintained despite compression forces (some of which are radially inward) due to the forces used to draw the cane into the HCF. That is, without the pumping of inert gas into the cane during drawing of the cane into the HCF, or where the conventional sealing material fails to achieve and maintain the pressure seal at the first end of the cane, the forces used to draw the cane into the HCF may damage the nested tubes, thereby affecting transmission of signals over the HCF during operational use of the HCF. After drawing the cane 105, the final length L_{c}, in some cases, is one of 5 kilometers (km), 10 km, 18 km, or longer.

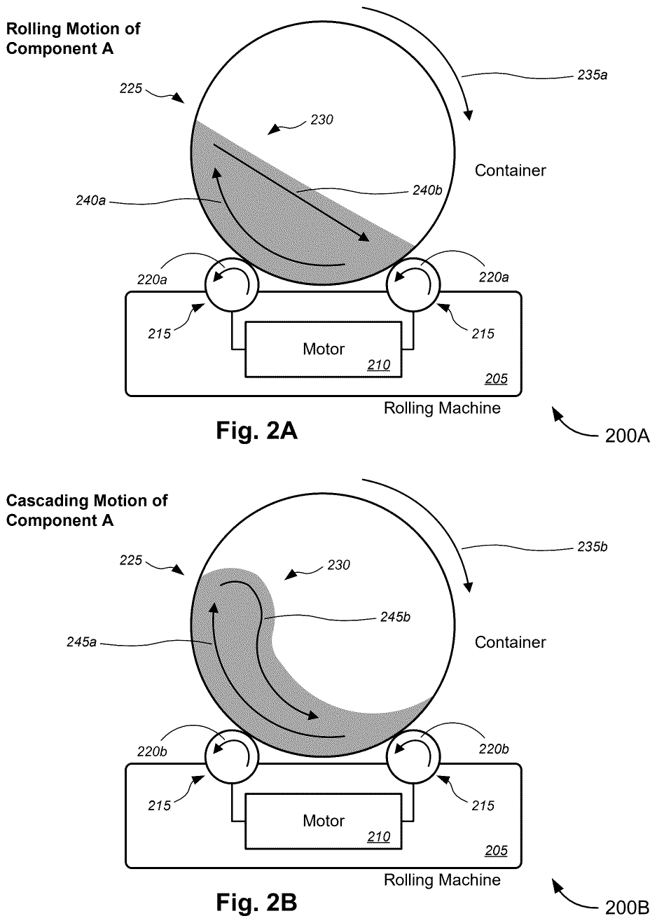

FIGS. 2A and 2B depict example fluid motions 200A and 200B that are caused to homogenize Component A of the rapid, heat curing sealing material of FIG. 1, when using a rolling machine. In each of FIGS. 2A and 2B, a rolling machine 205 is shown that includes a motor 210 that controls rollers 215 to (collectively and synchronously) rotate in a first direction (as denoted by the direction of arrows 220a or 200b, in this case, in the counter-clockwise direction). Rotation of the rollers 215 causes cylindrical or tubular containers (such as container 225), when placed on the rollers 215, to rotate in the opposite direction (as denoted by the direction of arrow 235a or 235b, in this case, in the clockwise direction). For Component A (e.g., a silicone polymer as described with respect to FIGS. 1 and 3-5), a Froude number between 0.070 and 0.080 is determined to provide a desired homogeneous consistency for Component A. As used herein, the Froude number refers to a measure of a balance between inertia forces (or drag-resistance force; denoted by arrow 240a in the Rolling Motion scenario of FIG. 2A at the lower end of the above-indicated range of Froude numbers or by arrow 245a in the Cascading Motion scenario of FIG. 2B at the upper end of the above-indicated range of Froude numbers) and gravitational forces (denoted by arrow 240b in the Rolling Motion scenario of FIG. 2A at the lower end of the above-indicated range of Froude numbers or by arrow 245b in the Cascading Motion scenario in the Cascading Motion scenario of FIG. 2B at the upper end of the above-indicated range of Froude numbers) for sedimentation particles in liquids.

By causing the rolling machine 205 to roll the container 225 at different speeds and durations based on a volume of Component A held by the container 225 when the container 225 is being rolled, homogenized consistency of the silicone polymer can be maintained. For instance, to maintain the Froude number of between 0.070 and 0.080, for a container 225 having an outer diameter of 10.5 cm and when the container is at a first volume, the first rotation speed of the rolling machine is set to 40 rpm and the first duration is set to 120 minutes (referred to herein as “Rolling Program 1”). In examples, the first volume corresponds to a volume of a container containing a new batch of the silicone polymer (also referred to herein as a “full tin” volume). For the 10.5 cm outer diameter container, at 40 rpm, the process results in about 14 rotations per minute for the container 225, which over 120 minutes results in 100,800 rotations.

In other cases, for the same sized container 225 and when the container is at a second volume less than the first volume, the first rotation speed of the rolling machine is set to 30 rpm and the first duration is set to 20 minutes (referred to herein as “Rolling Program 2”). In examples, the second volume corresponds to a volume of a container containing an in-use batch of the silicone polymer (also referred to herein as a “half-full tin” or “partially full tin” volume). For the 10.5 cm outer diameter container, at 30 rpm, the process results in about 9 rotations per minute for the container 225, which over 20 minutes results in 10,800 rotations. Either Rolling Program would result in one of the Rolling Motion of FIG. 2A or the Cascading Motion of FIG. 2B, either of which would be suitable for producing the desired homogeneous consistency for Component A (in this case, the silicone polymer).

The use of a rolling machine 205 for the preparation of Component A of the sealing material has additional benefits over other mechanical equipment that can be used for preparation of sealing materials in general (such as mechanical stirrers). Such additional benefits include an external type of non-invasive, no-contact type of homogenization, as compared with the internal type of invasive, direct contact type of homogenization with the use of a mechanical stirrer. There is also no need for cleaning with the use of the roller machine as compared with cleaning of impellers with the use of the mechanical stirrer. Whereas the mechanical stirrer approach is a hands-on approach requiring user presence for at least 10 minutes, the rolling machine approach is hands-free, which enables increase of productivity as rolling can be performed in parallel with other tasks.

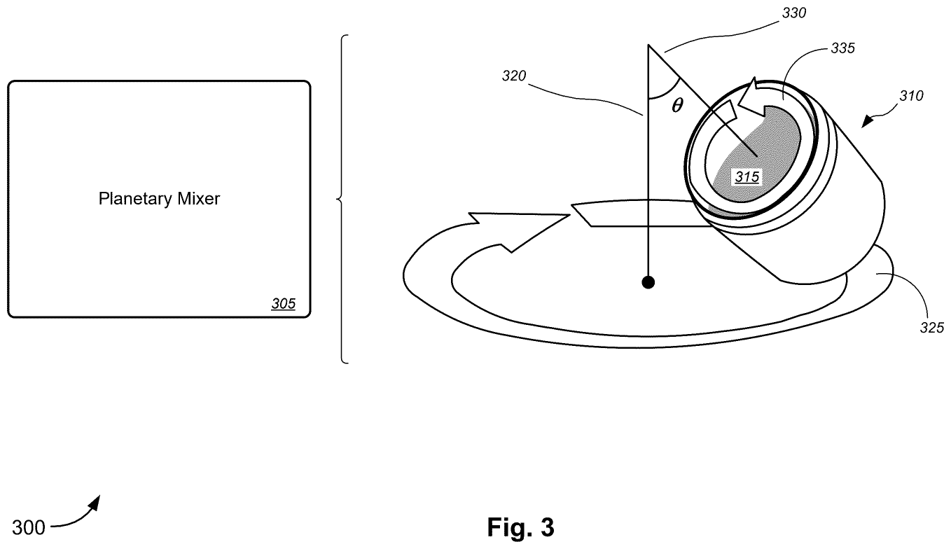

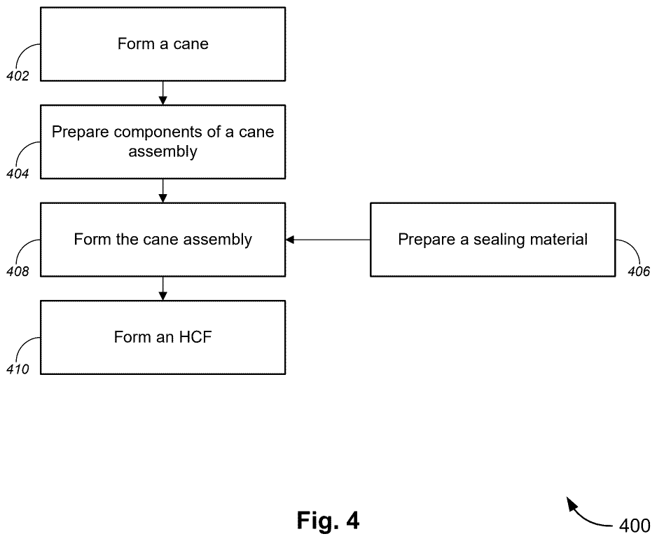

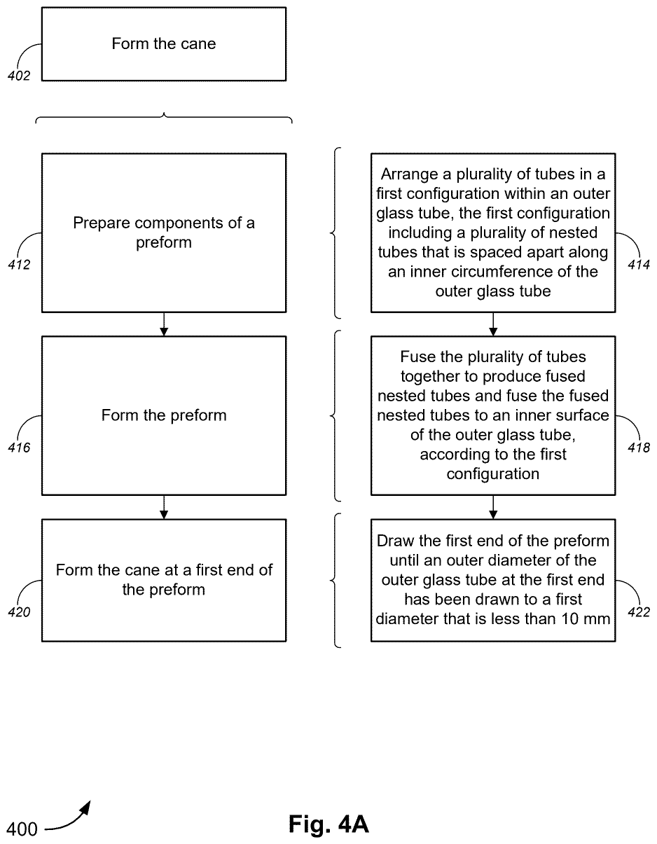

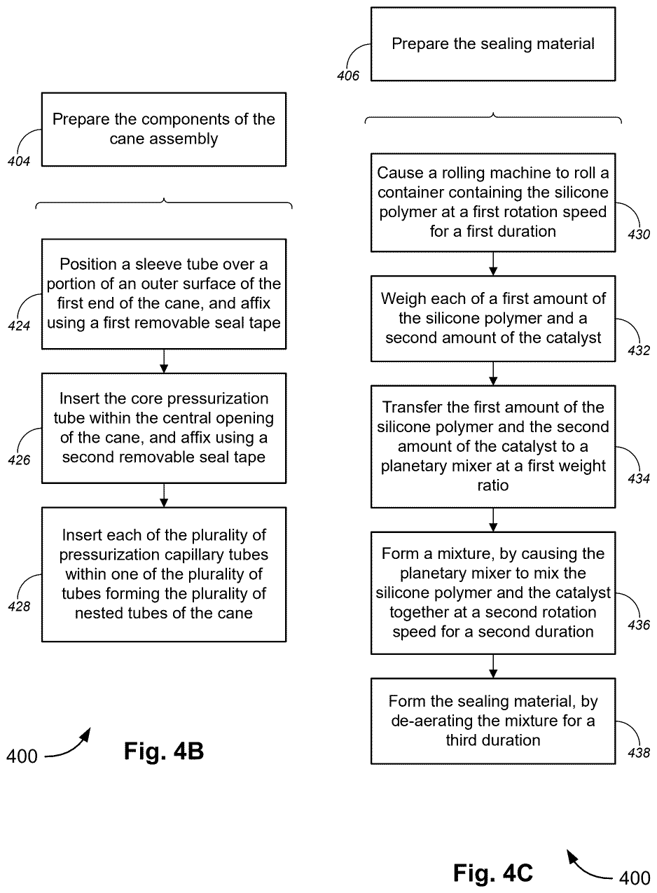

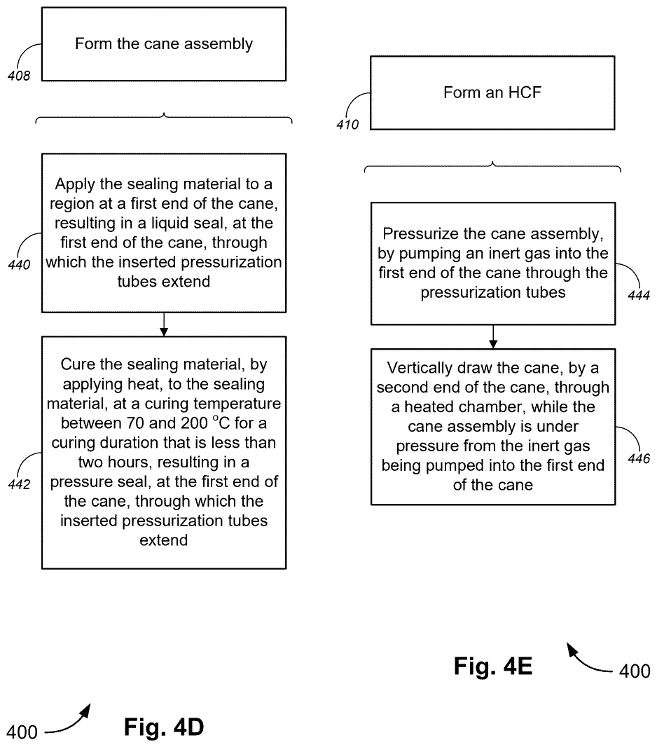

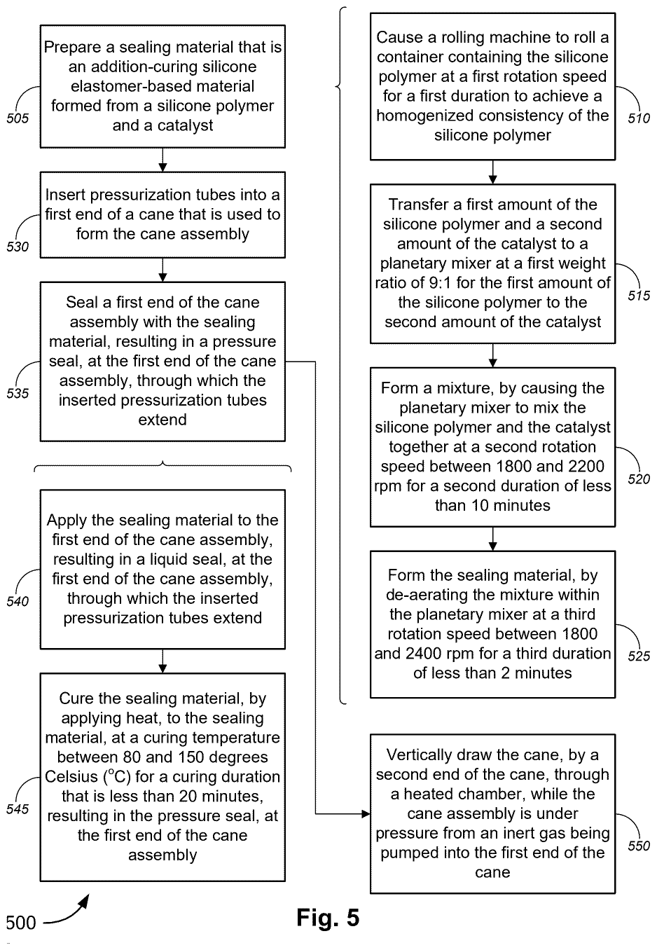

FIG. 3 depicts example motions 300 that are caused when mixing Components A and B of the rapid, heat curing sealing material of FIG. 1, when using a planetary mixer. FIG. 3 is directed to a planetary mixer 305 that is used to mix Components A and B (corresponding to the silicone polymer and the catalyst, respectively, as described herein) as a mixture 315 within a container 310 that is compatible with the planetary mixer 305. As shown in FIG. 3, the planetary mixer 305 causes the container 310 (and its contents, in this case, a mixture 315 of Components A and B) to revolve around axis 320 (as depicted by arrow 325) while being rotated about axis 330 (as depicted by arrow 335), the axis 330 being coaxial with an axis of container 310. The axes 320 and 330 are separated by an angle q, which includes one of 15, 30, 45, 60, or 75 degrees or an angle within a range between 10 and 80 degrees. In some cases, the kinetic energy caused by the planetary mixer is transferred as heat to the material being mixed (in this case, the mixture 315). As the mixture 315 is intended to be heat cured, such transfer of heat either facilitates/accelerates subsequent heat curing and/or accelerates a life-time of the mixture 315. Examples of rotations speeds and durations for mixing the mixture as well as for de-aerating the mixture (after mixing) are described below with respect to FIGS. 4, 4A-4E, and 5. As used herein, de-aerating refers to a process in which gas emissions from the mixture are removed by the machine (in this case, the planetary mixer). In examples, the planetary mixer applies a centrifugal force of over 400G, pushing the air bubbles to the walls of the jar. With the planetary movement, the bubbles move up and escape from the material. This is also an active process, utilizing both centrifugal force and kinetic movement. As used herein, outgassing refers to a natural release of gas from a solid or liquid, which can happen over time or can be sped up by variation in temperature and pressure. Degassing, on the other hand, refers to an intentional process to remove gas from a solid or liquid, typically through heating, applying a force (e.g., centrifugal force), or applying a vacuum. De-aerating alternatively refers to a process that is used to eliminate oxygen and other dissolved gases from a liquid to enhance its performance, and can be performed actively by heating, applying a force (e.g., centrifugal force), or tapping the liquid to move the bubbles upward and release them into the atmosphere.

When conventional sealing materials are used for sealing cane assemblies for forming HCFs, material compositions of those sealing materials may contaminate internal surfaces of the cane that becomes the internal surfaces of the HCF (after completion of the cane-drawing process through the heated chamber). This can result in outgassing of the contaminants during use of the HCF for data signal transmission. Outgassing of carbon dioxide (CO₂), in particular, can be problematic as the CO₂ absorption of optical signals that impacts transmission loss was observed at a wavelength of 1534 nm. That is, optical signals transmitted over the HCF at a wavelength of 1534 nm were absorbed by CO₂ contaminants that outgas from internal spaces or surfaces of the HCF, with conventional sealing materials contributing to the CO₂ contaminants. The combination of composition of the addition-curing silicone elastomer-based material (as described herein) with the de-aerating step (using the planetary mixer 305) results in production of HCFs that exhibit CO₂ outgassing levels having average transmission losses less than 0.05 dB/km, in some cases, less than 0.03 dB/km, and in still other cases, less than 0.15 dB/km.

The use of the planetary mixer 305, as compared with a mechanical stirrer, allows for a number of benefits including: (i) minimization of process variables arising from human interference due to the automatic process provided by the planetary mixer; (ii) inclusion of a degassing feature in addition to a mixing feature; (iii) no contamination due to insertion of external tools rather than internal, invasive, and direct contact type of mixing with the mechanical stirrer; (iv) obviating cleaning and reducing chances for contamination, with the use of disposable jars compared to the need for cleaning impellers of the mechanical stirrer; and (v) time savings due to a simpler process for mixing and degassing or de-aerating with the planetary mixer compared with the mechanical stirrer.

FIGS. 4 and 4A-4E depict an example method 400 for implementing hollow core fiber manufacturing or, more particularly, for implementing sealing of a cane assembly using a rapid, heat curing sealing material for hollow core fiber manufacturing. FIG. 4 is directed to high-level processes of the method 400 for implementing sealing of a cane assembly using a rapid, heat curing sealing material for hollow core fiber manufacturing, while each of FIGS. 4A-4E is directed to detailed processes for one of the high-level processes of the method 400.

In the example of FIG. 4, method 400, at operation 402, includes forming a cane (e.g., cane 105 of FIG. 1), which is described in greater detail below with respect to FIG. 4A. At operation 404, method 400 includes preparing components of a cane assembly (e.g., cane assembly 165 of FIG. 1), which is formed using the cane (which is formed at operation 402) and which is described in greater detail below with respect to FIG. 4B. At operation 406, method 400 includes preparing a sealing material (e.g., sealing material 155 of FIG. 1), which is described in greater detail below with respect to FIG. 4C. At operation 408, method 400 includes forming the cane assembly, from the components of the cane assembly (which are prepared at operation 404) and the sealing material (which is prepared at operation 406), which is described in greater detail below with respect to FIG. 4D. At operation 410, method 400 includes forming an HCF, using the cane assembly (which is formed at operation 408), which is described in greater detail below with respect to FIG. 4E. As described above (e.g., with respect to FIG. 1), the cane includes an outer glass tube (e.g., the outer glass tube 110 of FIG. 1) and a plurality of tubes (e.g., the plurality of tubes 115 of FIG. 1), where groups of tubes among the plurality of tubes are nested to form a plurality of nested tubes (e.g., the plurality of nested tubes 120 of FIG. 1) in a first configuration. The plurality of nested tubes in the first configuration is spaced apart along, and fused to, an inner circumference of the outer glass tube. In examples, the first configuration corresponds to a relative positioning of nested tubes within the HCF after drawing of the cane has been completed.

With reference to FIG. 4A, forming the cane (at operation 402) includes preparing components of a preform (at operation 412), in some cases, by arranging the plurality of tubes in the first configuration within the outer glass tube (at operation 414). In examples, forming the cane (at operation 402) also includes forming the preform (at operation 416), in some cases, by fusing the plurality of tubes together to produce fused nested tubes and by fusing the fused nested tubes to an inner surface of the outer glass tube along the inner circumference of the outer glass tube, according to the first configuration (at operation 418). Forming the cane (at operation 402) further includes forming the cane at a first end of the preform (at operation 420), in some cases, by drawing the first end of the preform until an outer diameter of the outer glass tube at the first end has been drawn to a first diameter that is less than 10 millimeters (mm) (at operation 422). Herein, in some cases, the first end of the preform corresponds to the first end of the cane. In some examples, the first end of the preform is drawn until the outer diameter of the outer glass tube is less than about 6 mm (in some cases, about 5.5 mm).

Referring to FIG. 4B, preparing the components of the cane assembly (at operation 404) includes positioning a sleeve tube (e.g., temporarily) over a portion of an outer surface of the first end of the cane, and affixing the sleeve tube to the portion of the outer surface of the first end of the cane using a first removable seal tape (e.g., a seal tape made from PTFE film) (at operation 424). In some examples, the cane assembly includes a sleeve tube, while in other examples, the cane assembly foregoes use of a sleeve tube. As described above with respect to FIG. 1, in some cases, the sleeve tube has an outer diameter of about 8.3 mm and an inner diameter of about 7.3 mm. In some cases, preparing the components of the cane assembly (at operation 404) also includes inserting a core pressurization tube (e.g., core pressurization tube 130 of FIG. 1) within a central opening of the cane (e.g., central opening 125a of FIG. 1) and affixing the core pressurization tube within the central opening of the cane using a second removable seal tape (at operation 426). In examples, preparing the components of the cane assembly (at operation 404) further includes inserting each of a plurality of pressurization capillary tubes (e.g., pressurization capillary tubes 135 of FIG. 1) within one of the plurality of tubes of the cane (e.g., tubes 115 of FIG. 1) forming the plurality of nested tubes of the cane.

Turning to FIG. 4C, the sealing material is an addition-curing silicone elastomer-based material that is formed from a silicone polymer and a catalyst. In examples, preparing the sealing material (at operation 406) includes causing a rolling machine (e.g., rolling machine 205 of FIG. 2A or 2B) to roll a container (e.g., container 225 of FIG. 2A or 2B) containing the silicone polymer (e.g., Component A 230 of FIG. 2A or 2B) at a first rotation speed for a first duration (at operation 430). As described above, the silicone polymer has a composition including PDMS and a quartz-based filler. In some cases, the silicone polymer also includes auxiliary components for cross-linking as well as functional groups. In examples, because the silicone polymer is composed of multiple different materials, the consistency of the silicone polymer fluid degrades over time due to settling of one or more materials relative to other materials in a composition of the silicone polymer. Accordingly, in various examples, the silicone polymer is rolled within the container to achieve a homogenized consistency, in some cases, by causing the rolling machine to roll the container at different speeds and durations based on a volume of the silicone polymer held by the container when the container is being rolled, to maintain a Froude number between 0.070 and 0.080 for the silicone polymer during rolling of the container. For instance, to maintain the Froude number of between 0.070 and 0.080, for an outer diameter of the container that is 10.5 cm and when the container is at a first volume, the first rotation speed of the rolling machine is set to 40 rpm and the first duration is set to 120 minutes (referred to herein as “Rolling Program 1”). In examples, the first volume corresponds to a volume of a container containing a new batch of the silicone polymer (also referred to herein as a “full tin” volume). In other cases, for the same sized container and when the container is at a second volume less than the first volume, the first rotation speed of the rolling machine is set to 30 rpm and the first duration is set to 20 minutes (referred to herein as “Rolling Program 2”). In examples, the second volume corresponds to a volume of a container containing an in-use batch of the silicone polymer (also referred to herein as a “half-full tin” or “partially full tin” volume).

In other examples, rather than being dependent upon only volume of the silicone polymer, selection of a Rolling Program for rolling a container of silicone polymer is based on whether and when the container had previously been rolled using a rolling machine. In an example, regardless of volume, for containers containing silicone polymer that resembles a new batch in terms of fluid consistency, level of homogeneity, or lack of homogeneity (i.e., one that has not been rolled at all or for a prolonged period (e.g., multiple weeks, months, or years)), Rolling Program 1 is used. In some cases, the materials in the silicone polymer for these scenarios are separated and/or the silicone polymer composition requires extended rolling to achieve a homogeneous consistency, Rolling Program 1 is used. On the other hand, regardless of volume, for containers containing silicone polymer that resembles a previously used batch in terms of fluid consistency, level of homogeneity, or lack of homogeneity (i.e., one that has been rolled recently (e.g., within a day, a week, or two weeks)), Rolling Program 2 is used (and, in some cases, repeated on a weekly basis). In some cases, the materials in the silicone polymer for these scenarios are only partially separated and/or the silicone polymer does not require extended rolling to achieve a homogeneous consistency.

In examples, after rolling the container for the first duration, preparing the sealing material (at operation 406) also includes weighing each of a first amount of the silicone polymer and a second amount of the catalyst (at operation 432), to obtain a first weight ratio of the first amount to the second amount. In some examples, the first weight ratio for the first amount of the silicone polymer to the second amount of the catalyst is 9:1. In some instances, preparing the sealing material (at operation 406) further includes transferring the first amount of the silicone polymer and the second amount of the catalyst to a planetary mixer (e.g., planetary mixer 305 of FIG. 3) at a first weight ratio (at operation 434). In some cases, preparing the sealing material (at operation 406) also includes forming a mixture, by causing the planetary mixer to mix the silicone polymer and the catalyst together at a second rotation speed for a second duration (at operation 436). In some examples, the second rotation speed at which the planetary mixer is set for mixing the silicone polymer and the catalyst is between 1800 and 2200 rpm and the second duration is set to less than 10 minutes. In other examples, the second rotation speed at which the planetary mixer is set for mixing the silicone polymer and the catalyst is about 2000±50 rpm or about 2000±100 rpm, and the second duration is set to less than 5 minutes. In examples, preparing the sealing material (at operation 406) further includes forming the sealing material, by de-aerating the mixture for a third duration (at operation 438). In some examples, de-aerating of the mixture is performed within the planetary mixer at a third rotation speed. In some cases, the third rotation speed at which the planetary mixer is set for de-aerating the mixture is between 1800 and 2400 rpm and the third duration is set to less than 2 minutes. In other cases, the third rotation speed at which the planetary mixer is set for de-aerating the mixture is one of about 2000±50 rpm, about 2000±1000 rpm, about 2200±50 rpm, about 2200±100 rpm, or between about 2000 and about 2200 rpm, and the third duration is set to less than 1 minute.

With reference to FIG. 4D, forming the cane assembly (at operation 408) includes applying a sealing material to a region at the first end of the cane, resulting in a liquid seal, at the first end of the cane, through which the inserted pressurization tubes (including the core pressurization tube and the plurality of pressurization capillary tubes) extend (at operation 440). In some examples, forming the cane assembly (at operation 408) further includes curing the sealing material, by applying heat, to the sealing material, at a curing temperature between 70 and 200° C. (in some cases, at a temperature range between 130 and 170° C. or between 140 and 160° C.) for a curing duration that is less than two hours, resulting in a pressure seal, at the first end of the cane, through which the inserted pressurization tubes extend (at operation 442). In some cases, the curing temperature and the curing duration that are used when curing the sealing material are between 80 and 150° C. and less than 20 minutes, respectively. In some instances, the curing temperature and the curing duration that are used when curing the sealing material are between 100 and 130° C. and less than 10 minutes, respectively. In other cases, the curing temperature and the curing duration that are used when curing the sealing material are about 150° C. and about 5 minutes, respectively. By comparison, conventional sealing materials are curable at about room temperature (e.g., about 23° C.), and require 24 hours or more to cure.

In some examples, applying heat to the sealing material comprises at least one of:
(a) heating the sealing material via at least one of conduction or radiation from a ring-shaped heating element of a band heater through which the region where the sealing material is applied is positioned;
(b) heating the region where the sealing material is applied, when the region is positioned within a heated chamber;
(c) heating the region where the sealing material is applied, using a laser-based heating element directed at the region;
(d) heating the region where the sealing material is applied, using a heated air blower directed at the region; or
(e) heating the region where the sealing material is applied, using an induction-based heating element positioned proximal or surrounding the region.

Referring to FIG. 4E, forming the HCF (at operation 410) includes pressurizing the cane assembly, by pumping an inert gas into the first end of the cane through the pressurization tubes (at operation 444). In some examples, the inert gas includes one or more of argon, nitrogen, helium, or other inert gas. In examples, forming the HCF (at operation 410) further includes vertically drawing the cane, by a second end of the cane, through a heated chamber, while the cane assembly is under pressure from the inert gas being pumped into the first end of the cane (at operation 446). In this manner, the delicate structures of the nested tubes are maintained despite compression forces (some of which are radially inward) due to the forces used to draw the cane into the HCF. That is, without the pumping inert gas into the cane during drawing of the cane into the HCF, or where the sealing material fails to achieve and maintain the pressure seal at the first end of the cane, then the forces used to draw the cane into the HCF may damage the nested tubes, thereby affecting transmission of signals over the HCF during operational use of the HCF.

FIG. 5 depicts another example method 500 for implementing hollow core fiber manufacturing or, more particularly, for implementing sealing of a cane assembly using a rapid, heat curing sealing material for hollow core fiber manufacturing. Example method 500 is mainly directed to sealing a cane assembly for HFC manufacturing. At least portions of example method 500 are otherwise similar, if not identical to corresponding portions of example method 400 of FIG. 4, and corresponding descriptions thereof are applicable to the corresponding portions of example method 500 of FIG. 5.

With reference to FIG. 5, method 500, at operation 505, includes preparing a sealing material that is an addition-curing silicone elastomer-based material formed from a silicone polymer and a catalyst. In examples, preparing the sealing material (at operation 505) includes causing a rolling machine to roll a container containing a silicone polymer at a first rotation speed for a first duration to achieve a homogenized consistency of the silicone polymer (at operation 510). In some cases, to achieve a homogenized consistency of the silicone polymer, the rolling machine is caused to roll the container at different speeds and durations based on a volume of the silicone polymer held by the container when the container is being rolled, to maintain a Froude number between 0.070 and 0.080 for the silicone polymer during rolling of the container, in a similar manner as described above with respect to FIG. 4C.

In some examples, preparing the sealing material (at operation 505) further includes, after rolling the container for the first duration, transferring a first amount of the silicone polymer and a second amount of a catalyst to a planetary mixer at a first weight ratio of 9:1 for the first amount of the silicone polymer to the second amount of the catalyst (at operation 515), in a similar manner as described above with respect to FIG. 4C. In examples, preparing the sealing material (at operation 505) also includes forming a mixture, by causing the planetary mixer to mix the silicone polymer and the catalyst together at a second rotation speed between 1800 and 2200 rpm for a second duration of less than 10 minutes (at operation 520), in a similar manner as described above with respect to FIG. 4C. In some examples, preparing the sealing material (at operation 505) includes forming a sealing material, by de-aerating the mixture within the planetary mixer at a third rotation speed between 1800 and 2400 rpm for a third duration of less than 2 minutes (at operation 525), in a similar manner as described above with respect to FIG. 4C.

Method 500, at operation 530, further includes inserting pressurization tubes into a first end of a cane that is used to form the cane assembly. As described above with respect to FIG. 4B, the pressurization tubes include a core pressurization tube that is inserted (and affixed) in a central opening of the cane and a plurality of pressurization capillary tubes each of which is inserted in one of a plurality of tubes groups of which are used to form a plurality of nested tubes of the cane. At operation 535, method 500 further includes sealing a first end of the cane assembly with the sealing material, resulting in a pressure seal, at the first end of the cane assembly, through which the inserted pressurization tubes extend. In examples, sealing the first end of the cane assembly with the sealing material (at operation 535) includes applying the sealing material to the first end of the cane assembly, resulting in a liquid seal, at the first end of the cane assembly, through which the inserted pressurization tubes extend (at operation 540). In some examples, sealing the first end of the cane assembly with the sealing material (at operation 535) further includes curing the sealing material, by applying heat, to the sealing material, at a curing temperature between 80 and 150° C. for a curing duration that is less than 20 minutes, resulting in the pressure seal, at the first end of the cane assembly (at operation 545). Method 500 further includes, at operation 550, vertically drawing the cane, by a second end of the cane, through a heated chamber, to form an HCF, while the cane assembly is under pressure from an inert gas being pumped into the first end of the cane. The pressure seal prevents the inert gas that is pumped into the cane through the pressurization tubes from escaping through the first end of the cane assembly during drawing of the cane. After the HCF has been formed, the pressurization tubes, the sealing material, and the sleeve tube (if used), as well as the seal tapes, are removed.

While the techniques and procedures in methods 400, 500 are depicted and/or described in a certain order for purposes of illustration, it should be appreciated that certain procedures may be reordered and/or omitted within the scope of various embodiments. Moreover, while the methods 400, 500 may be implemented by or with (and, in some cases, are described below with respect to) the systems, examples, or embodiments 100, 200A, 200B, and 300 of FIGS. 1, 2A, 2B, and 3, respectively (or components thereof), such methods may also be implemented using any suitable hardware (or software) implementation. Similarly, while each of the systems, examples, or embodiments 100, 200A, 200B, and 300 of FIGS. 1, 2A, 2B, and 3, respectively (or components thereof), can operate according to the methods 400, 500 (e.g., by executing instructions embodied on a computer readable medium), the systems, examples, or embodiments 100, 200A, 200B, and 300 of FIGS. 1, 2A, 2B, and 3 can each also operate according to other modes of operation and/or perform other suitable procedures.

As should be appreciated from the foregoing, the present technology provides multiple technical benefits and solutions to technical problems. For instance, producing HCFs generally raises multiple technical problems. For instance, one technical problem includes curing of conventional sealing materials at an end of an HCF cane that is used for producing HCFs requiring 24 hours or longer. Another technical problem includes such conventional sealing materials outgassing organic or other gases that can contaminate interior spaces or surfaces of HCFs or HCF canes during HCF manufacturing, which results in transmission losses for optical signals carried by the HCFs increasing due to absorption by the contaminant gases. The present technology provides for sealing of a cane assembly using a rapid, heat curing sealing material for HCF manufacturing. The rapid, heat curing sealing material is an addition-curing silicone elastomer-based material that is non-toxic, that can be cured in a fraction of the time that conventional sealing materials require to cure (e.g., 5-10 mins or up to two hours), that can be cured at moderate temperatures during that curing time (e.g., between 70 and 200° C., between 130 and 170° C., or between 140 and 160° C.) that is stable over varying humidity conditions, and has low outgassing properties that lower emission of organic gases (e.g., CO₂) thus mitigating risk of contaminating interior spaces or surfaces of HCFs that could subsequently impact transmission loss due to absorption by the organic gases. With respect to the low outgassing properties, the process steps (e.g., de-aerating step as described in detail above) together with the composition of the addition-curing silicone elastomer-based material (as also described in detail above) result in production of HCFs that exhibit CO₂ outgassing levels having average transmission losses less than 0.05 dB/km, in some cases, less than 0.03 dB/km, and in still other cases, less than 0.15 dB/km, as compared with the greater than 0.5 dB/km transmission losses due to CO₂ or other contaminant gases that are at least in part contributed by conventional sealing materials used to form HCFs. In addition, the addition-curing silicone elastomer-based material enables easier batching and preparation, and is also suitable for automated preparation. Further, with the processes used for preparing the addition-curing silicone elastomer-based material, in addition to the faster processing times (due to rapid curing), enhanced reliability (from the use of the rolling machine and the planetary mixer, etc.), and improved usability of the sealing material are achievable with the present technology.

In this detailed description, wherever possible, the same reference numbers are used in the drawing and the detailed description to refer to the same or similar elements. In some instances, a sub-label is associated with a reference numeral to denote one of multiple similar components. When reference is made to a reference numeral without specification to an existing sub-label, it is intended to refer to all such multiple similar components. In some cases, for denoting a plurality of components, the suffixes “a” through “n” may be used, where n denotes any suitable non-negative integer number (unless it denotes the number 14, if there are components with reference numerals having suffixes “a” through “m” preceding the component with the reference numeral having a suffix “n”), and may be either the same or different from the suffix “n” for other components in the same or different figures. For example, for component #1 X05a-X05n, the integer value of n in X05n may be the same or different from the integer value of n in X10n for component #2 X10a-X10n, and so on. In other cases, other suffixes (e.g., s, t, u, v, w, x, y, and/or z) may similarly denote non-negative integer numbers that (together with n or other like suffixes) may be either all the same as each other, all different from each other, or some combination of same and different (e.g., one set of two or more having the same values with the others having different values, a plurality of sets of two or more having the same value with the others having different values).

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

In this detailed description, for the purposes of explanation, numerous specific details are set forth to provide a thorough understanding of the described embodiments. It will be apparent to one skilled in the art, however, that other embodiments of the present invention may be practiced without some of these specific details. In other instances, certain structures and devices are shown in block diagram form. While aspects of the technology may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the detailed description does not limit the technology, but instead, the proper scope of the technology is defined by the appended claims. Examples may take the form of a hardware implementation, or an entirely software implementation, or an implementation combining software and hardware aspects. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features. The detailed description is, therefore, not to be taken in a limiting sense.

Aspects of the present invention, for example, are described above with reference to block diagrams and/or operational illustrations of methods, systems, and computer program products according to aspects of the invention. The functions and/or acts noted in the blocks may occur out of the order as shown in any flowchart. For example, two blocks shown in succession may in fact be executed substantially concurrently or the blocks may sometimes be executed in the reverse order, depending upon the functionalities and/or acts involved. Further, as used herein and in the claims, the phrase “at least one of element A, element B, or element C” (or any suitable number of elements) is intended to convey any of: element A, element B, element C, elements A and B, elements A and C, elements B and C, and/or elements A, B, and C (and so on).

The description and illustration of one or more aspects provided in this application are not intended to limit or restrict the scope of the invention as claimed in any way. The aspects, examples, and details provided in this application are considered sufficient to convey possession and enable others to make and use the best mode of the claimed invention. The claimed invention should not be construed as being limited to any aspect, example, or detail provided in this application. Regardless of whether shown and described in combination or separately, the various features (both structural and methodological) are intended to be selectively rearranged, included, or omitted to produce an example or embodiment with a particular set of features. Having been provided with the description and illustration of the present application, one skilled in the art may envision variations, modifications, and alternate aspects, examples, and/or similar embodiments falling within the spirit of the broader aspects of the general inventive concept embodied in this application that do not depart from the broader scope of the claimed invention.

What is claimed is:

1. A method for sealing a cane assembly for hollow-core fiber (“HCF”) manufacturing, the method comprising:
causing a rolling machine to roll a container containing a silicone polymer at a first rotation speed for a first duration to achieve a homogenized consistency of the silicone polymer, by causing the rolling machine to roll the container at different speeds and durations based on a volume of the silicone polymer held by the container when the container is being rolled, to maintain a Froude number between 0.070 and 0.080 for the silicone polymer during rolling of the container, the silicone polymer having a composition including polydimethylsiloxane (“PDMS”) and a quartz-based filler;
after rolling the container for the first duration, transferring a first amount of the silicone polymer and a second amount of a catalyst to a planetary mixer at a first weight ratio of 9:1 for the first amount of the silicone polymer to the second amount of the catalyst;
forming a mixture, by causing the planetary mixer to mix the silicone polymer and the catalyst together at a second rotation speed between 1800 and 2200 revolutions per minute (rpm) for a second duration of less than 10 minutes;
forming a sealing material, by de-aerating the mixture within the planetary mixer at a third rotation speed between 1800 and 2400 rpm for a third duration of less than 2 minutes, wherein the sealing material is an addition-curing silicone elastomer-based material;
inserting pressurization tubes into a first end of a cane that is used to form the cane assembly; and
sealing a first end of the cane assembly with the sealing material, resulting in a pressure seal, at the first end of the cane assembly, through which the inserted pressurization tubes extend.

2. The method of claim 1, wherein sealing the first end of the cane assembly with the sealing material comprises:
applying the sealing material to the first end of the cane assembly, resulting in a liquid seal, at the first end of the cane assembly, through which the inserted pressurization tubes extend; and
curing the sealing material, by applying heat, to the sealing material, at a curing temperature between 80 and 150 degrees Celsius (° C.) for a curing duration that is less than 20 minutes, resulting in the pressure seal, at the first end of the cane assembly, that prevents an inert gas that is pumped into the cane through the pressurization tubes from escaping through the first end of the cane assembly during vertical drawing of a second end of the cane to form an HCF.

3. The method of claim 1, wherein to maintain the Froude number of between 0.070 and 0.080, for an outer diameter of the container that is 10.5 centimeters (cm),
when the container is at a first volume, the first rotation speed of the rolling machine is set to 40 rpm and the first duration is set to 120 minutes, wherein the first volume corresponds to a volume of a container containing a new batch of the silicone polymer; and
when the container is at a second volume less than the first volume, the first rotation speed of the rolling machine is set to 30 rpm and the first duration is set to 20 minutes, wherein the second volume corresponds to a volume of a container containing a previously used batch of the silicone polymer.

4. A manufacturing method for forming a hollow-core fiber (“HCF”) by first forming a cane assembly, the method comprising:
inserting pressurization tubes into a first end of a cane;
applying a sealing material to a region at the first end of the cane, resulting in a liquid seal, at the first end of the cane, through which the inserted pressurization tubes extend, wherein the sealing material is an addition-curing silicone elastomer-based material;
curing the sealing material, by applying heat, to the sealing material, at a curing temperature between 70 and 200 degrees Celsius (° C.) for a curing duration that is less than two hours, resulting in a pressure seal, at the first end of the cane, through which the inserted pressurization tubes extend, the cane assembly comprising an arrangement of the cane, the inserted pressurization tubes, and the cured sealing material resulting from the inserting, applying, and curing steps;
pressurizing the cane assembly, by pumping an inert gas into the first end of the cane through the pressurization tubes; and
forming the HCF, by vertically drawing the cane, by a second end of the cane, through a heated chamber, while the cane assembly is under pressure from the inert gas being pumped into the first end of the cane.

5. The method of claim 4, wherein the cane includes an outer glass tube and a plurality of tubes, wherein groups of tubes among the plurality of tubes are nested to form a plurality of nested tubes in a first configuration, the plurality of nested tubes in the first configuration being spaced apart along, and fused to, an inner circumference of the outer glass tube, wherein the pressurization tubes include a core pressurization tube and a plurality of pressurization capillary tubes, wherein inserting the pressurization tubes into the first end of the cane comprises:
inserting and affixing the core pressurization tube within a central opening of the cane; and
inserting each of the plurality of pressurization capillary tubes within one of the plurality of tubes of the cane.

6. The method of claim 5, further comprising, prior to preparing the cane assembly, forming the cane, including:
preparing components of a preform, by arranging the plurality of tubes in the first configuration within the outer glass tube, the first configuration corresponding to a relative positioning of nested tubes within the HCF after drawing of the cane has been completed;
forming the preform, by fusing the plurality of tubes together to produce fused nested tubes and by fusing the fused nested tubes to an inner surface of the outer glass tube along the inner circumference of the outer glass tube, according to the first configuration; and
forming the cane at a first end of the preform, by drawing the first end of the preform until an outer diameter of the outer glass tube at the first end has been drawn to a first diameter that is less than 10 millimeters (mm), the first end of the preform corresponding to the first end of the cane.

7. The method of claim 4, wherein the addition-curing silicone elastomer-based material is formed from a silicone polymer and a catalyst, wherein the method further comprises, prior to applying the sealing material, preparing the sealing material, including:
causing a rolling machine to roll a container containing the silicone polymer at a first rotation speed for a first duration;
after rolling the container for the first duration, transferring a first amount of the silicone polymer and a second amount of the catalyst to a planetary mixer at a first weight ratio;
forming a mixture, by causing the planetary mixer to mix the silicone polymer and the catalyst together at a second rotation speed for a second duration; and
forming the sealing material, by de-aerating the mixture for a third duration.

8. The method of claim 7, wherein the silicone polymer has a composition including polydimethylsiloxane (“PDMS”) and a quartz-based filler, wherein the first weight ratio for the first amount of the silicone polymer to the second amount of the catalyst is 9:1.

9. The method of claim 8, wherein the silicone polymer is rolled within the container to achieve a homogenized consistency, by causing the rolling machine to roll the container at different speeds and durations based on a volume of the silicone polymer held by the container when the container is being rolled, to maintain a Froude number between 0.070 and 0.080 for the silicone polymer during rolling of the container.

10. The method of claim 9, wherein to maintain the Froude number of between 0.070 and 0.080, for an outer diameter of the container that is 10.5 centimeters (cm),
when the container is at a first volume, the first rotation speed of the rolling machine is set to 40 revolutions per minute (rpm) and the first duration is set to 120 minutes, wherein the first volume corresponds to a volume of a container containing a new batch of the silicone polymer; and
when the container is at a second volume less than the first volume, the first rotation speed of the rolling machine is set to 30 rpm and the first duration is set to 20 minutes, wherein the second volume corresponds to a volume of a container containing a previously used batch of the silicone polymer.

11. The method of claim 7, wherein the second rotation speed at which the planetary mixer is set for mixing the silicone polymer and the catalyst is between 1800 and 2200 rpm and the second duration is set to less than 10 minutes.

12. The method of claim 11, wherein de-aerating of the mixture is performed within the planetary mixer at a third rotation speed, wherein the third rotation speed at which the planetary mixer is set for de-aerating the mixture is between 1800 and 2400 rpm and the third duration is set to less than 2 minutes.

13. The method of claim 4, wherein the curing temperature and the curing duration that are used when curing the sealing material are between 80 and 150° C. and less than 20 minutes, respectively.

14. The method of claim 4, wherein applying heat to the sealing material comprises at least one of:
heating the sealing material via at least one of conduction or radiation from a ring-shaped heating element of a band heater through which the region where the sealing material is applied is positioned;
heating the region where the sealing material is applied, when the region is positioned within a heated chamber;
heating the region where the sealing material is applied, using a laser-based heating element directed at the region;
heating the region where the sealing material is applied, using a heated air blower directed at the region; or
heating the region where the sealing material is applied, using an induction-based heating element positioned proximal or surrounding the region.

15. A cane assembly that is used in forming a hollow-core fiber (“HCF”), the cane assembly comprising:
a cane, comprising:
an outer glass tube having an outer diameter that has been drawn to a first diameter that is less than 10 mm;
a plurality of tubes, groups of tubes among which are nested and fused to form a plurality of nested tubes of the cane, the plurality of nested tubes being spaced apart along an inner circumference of the outer glass tube and being fused to an inner surface of the outer glass tube; and
a central opening corresponding to a first space defined by the inner circumference of the outer glass tube and an outer circumference of each of the plurality of nested tubes;
a core pressurization tube that is inserted and affixed within the central opening of the cane;
a plurality of pressurization capillary tubes each of which is inserted, at a first end of the cane, in one of the plurality of tubes that is arranged to form the plurality of nested tubes of the cane;
a sleeve tube through which the first end of the cane has been inserted, the sleeve tube being affixed to a portion of an outer surface of the first end of the cane; and
a sealing material that, after being heat cured at a curing temperature between 70 and 200 degrees Celsius (° C.) for a curing duration that is less than two hours, forms a pressure seal, at the first end of the cane, that prevents an inert gas that is pumped into the cane through the core pressurization tube and the plurality of pressurization capillary tubes from escaping through the first end of the cane assembly during vertical drawing of a second end of the cane to form an HCF, the sealing material being an addition-curing silicone elastomer-based material including a mixture containing a silicone polymer and a catalyst at a weight ratio of 9:1.

16. The cane assembly of claim 15, wherein the addition-curing silicone elastomer-based material is formed from the silicone polymer and the catalyst, by:
rolling a container containing the silicone polymer at a first rotation speed for a first duration, using a rolling machine;
after rolling the container, transferring a first amount of the silicone polymer and a second amount of the catalyst to a planetary mixer at a first weight ratio;
mixing the silicone polymer and the catalyst together at a second rotation speed for a second duration, using the planetary mixer, to form a mixture; and
de-aerating the mixture for a third duration;
wherein the silicone polymer has a composition including polydimethylsiloxane (“PDMS”) and a quartz-based filler.

17. The cane assembly of claim 16, wherein the silicone polymer is rolled within the container to achieve a homogenized consistency, by causing the rolling machine to roll the container at different speeds and durations based on a volume of the silicone polymer held by the container when the container is being rolled, to maintain a Froude number between 0.070 and 0.080 for the silicone polymer during rolling of the container.

18. The cane assembly of claim 17, wherein to maintain the Froude number of between 0.070 and 0.080, for an outer diameter of the container that is 10.5 centimeters (cm),
when the container is at a first volume, the first rotation speed of the rolling machine is set to 40 revolutions per minute (rpm) and the first duration is set to 120 minutes, wherein the first volume corresponds to a volume of a container containing a new batch of the silicone polymer; and
when the container is at a second volume less than the first volume, the first rotation speed of the rolling machine is set to 30 rpm and the first duration is set to 20 minutes, wherein the second volume corresponds to a volume of a container containing a previously used batch of the silicone polymer.

19. The cane assembly of claim 16, wherein the second rotation speed at which the planetary mixer is set when mixing the silicone polymer and the catalyst is between 1800 and 2200 rpm and the second duration is set to less than 10 minutes, wherein de-aerating of the mixture is performed within the planetary mixer at a third rotation speed, wherein the third rotation speed at which the planetary mixer is set for de-aerating the mixture is between 1800 and 2400 rpm and the third duration is set to less than 2 minutes, wherein the curing temperature and the curing duration that are used when curing the sealing material are between 80 and 150° C. and less than 20 minutes, respectively.

20. The cane assembly of claim 16, wherein the HCF that is formed using the sealing material exhibits carbon dioxide (“CO₂”) outgassing levels having average transmission losses less than 0.05 decibels per kilometer (dB/km).
